(19) United States
(12) Patent Application Publication
(10) Pub. No.: US 2026/0324815 A1
(43) Pub. Date: Oct. 22, 2026

(54) ELASTIC CONNECTION MECHANISM AND APPLICATION

(71) Applicant: Guangdong Yifengsheng Technology Co., Ltd, Dongguan (CN)

(72) Inventors: Yin Ning Harry Chan, Dongguan (CN); Aihua Wu, Dongguan (CN); Haixia Zhu, Dongguan (CN); Xin Su, Dongguan (CN)

(21) Appl. No.: 19/230,129

(22) Filed: Jun. 6, 2025

(30) Foreign Application Priority Data
Apr. 18, 2025 (CN) 202510493305.9

(51) Int. Cl. A44C 5/10

(52) U.S. Cl. CPC A44C 5/107

(57) ABSTRACT

An elastic connection mechanism includes a sleeve, a spring and rod bodies in a cavity of the sleeve, and adopts an integrated design. In one embodiment, when the spring is in an extended state, the base of the second rod body abuts against the base of the first rod body. When the second preset structural member pulls the second rod body to move outward, the base of the second rod body pushes the spring to compress. When the spring is extended, the base of the second rod body rebounds and abuts against the base of the first rod body. Similarly, in another embodiment, when the second preset structural member pulls the third rod body to move outward, the base of the third rod body pushes the spring to compress. When the spring is extended, the base of the third rod body rebounds and abuts against the bottom of the cavity.

### CROSS REFERENCE TO RELATED APPLICATIONS

The present application claims the benefit of Chinese Patent Application No. 2025104933059 filed on Apr. 18, 2025, the contents of which are incorporated herein by reference in their entirety.

### TECHNICAL FIELD

The present invention relates to the field of connectors for transmitting rotation, in particular to an elastic connection mechanism and application.

### BACKGROUND TECHNOLOGY

Connectors for pulling and rotating are often used in computer numerical control machining equipment, pneumatic clamps and other devices. Their main function is to connect two ends and provide telescopic and rotating movements. However, in production practice, connectors are usually composed of multiple components, with complex structures, inconvenient production and assembly, difficult debugging, and high maintenance costs.

### SUMMARY OF THE INVENTION

In order to overcome the shortcomings of the prior art, the present invention provides an elastic connection mechanism which adopts an integrated design, has a simple structure, and is convenient for production, assembly, replacement and maintenance.

An elastic connection mechanism includes a sleeve, a spring, a first rod body and a second rod body. The sleeve is provided with a cavity extending through the sleeve, and steps are provided at outlets at both ends of the cavity. The first rod body and the second rod body each include a base matching the diameter of the cavity, and a needle rod having a diameter smaller than the diameter of the base and integrally connected to the base.

The base of the first rod body is positioned in the cavity and abuts against the step on one side of the sleeve. The needle rod of the first rod body extends out of the cavity, and is configured to connect to a first preset structural member.

The spring is sleeved on the needle rod of the second rod body. The base of the second rod body is positioned in the cavity. One end of the base of the second rod body is arranged opposite to the base of the first rod body, and the spring is located between another end of the base of the second rod body and the step on another side of the sleeve. The needle rod of the second rod body extends out of the cavity, and is configured to connect a second preset structural member.

When the spring is in an extended state, the base of the second rod body abuts against the base of the first rod body; and when the second rod body moves in a direction away from the first rod body, the base of the second rod body compresses the spring to a compressed state.

An elastic connection mechanism includes a sleeve, a spring and a third rod body. A fixing rod is provided at one end of the sleeve. A cavity is provided in another end of the sleeve, and a step is provided at an outlet of the cavity. The third rod body includes a base matching the diameter of the cavity, and a needle rod having a diameter smaller than the diameter of the base and connected to the base in one piece.

The fixing rod of the sleeve is configured to connect to a first preset structural member.

The spring is sleeved on the needle rod of the third rod body. The base of the third rod body is positioned in the cavity. One end of the base of the third rod body is arranged opposite to a bottom of the cavity, and the spring is located between another end of the base of the third rod body and the step of the sleeve. The needle rod of the third rod body extends out of the cavity, and is configured to connect to a second preset structural member.

When the spring is in an extended state, the base of the third rod body abuts against the bottom of the cavity; and when the third rod body moves in a direction away from the bottom of the cavity, the base of the third rod body compresses the spring to a compressed state.

A device based on an elastic connection mechanism includes the above-mentioned elastic connection mechanism, a first preset structural member, and a second preset structural member. The first preset structural member and the second preset structural member are respectively connected to the needle rod of the first rod body and the needle rod of the second rod body; or, the first preset structural member and the second preset structural member are respectively connected to the fixed rod of the sleeve and the needle rod of the third rod body.

The elastic connection mechanism and the device applying the mechanism provided by the present invention have the following working principles: in one embodiment, when the spring is in an extended state, the base of the second rod body abuts against the base of the first rod body. When the second preset structural member pulls the second rod body to move outward, the base of the second rod body pushes the spring to compress. When the spring is extended, the base of the second rod body rebounds and abuts against the base of the first rod body. Similarly, in another embodiment, when the second preset structural member pulls the third rod body to move outward, the base of the third rod body pushes the spring to compress. When the spring is extended, the base of the third rod body rebounds and abuts against the bottom of the cavity.

Compared with the existing technology, the elastic connection mechanism is composed of a sleeve, a spring and rod bodies. It adopts an integrated design, has a simple structure, is easy to produce and assemble, replace and maintain, and is conducive to reducing costs. At the same time, it can be made into kits of different sizes according to actual needs, and is suitable for various application scenarios such as machinery, computer numerical control processing equipment, fixtures, wearable terminal products, etc.

### BRIEF DESCRIPTION OF THE DRAWINGS

FIG. 1 is a perspective view of an elastic connection mechanism in Embodiment 1;

FIG. 2 is an exploded view of the elastic connection mechanism in Embodiment 1;

FIG. 3 is a cross-sectional view of the elastic connection mechanism in Embodiment 1;

FIG. 4 is another cross-sectional view of the elastic connection mechanism in Embodiment 1;

FIG. 5 is a perspective view of the elastic connection mechanism in Embodiment 2;

FIG. 6 is an exploded view of the elastic connection mechanism in Embodiment 2;

FIG. 7 is a cross-sectional view of the elastic connection mechanism in Embodiment 2;

FIG. 8 is a perspective view of a watchband unit based on the elastic connection mechanism;

FIG. 9 is an exploded view of the watchband unit based on the elastic connection mechanism;

FIG. 10 is a cross-sectional view of the watchband unit based on the elastic connection mechanism.

The symbols in the drawings of the specification are as follows:
100. Elastic connection mechanism; 1. Sleeve; 11. Cavity; 12. Step; 13. Fixed rod; 2. Spring; 31. First rod body; 32. Second rod body; 33. Third rod body; 34. Base; 35. Needle rod; 4. Positioning shaft; 5. First connection block; 51. Through slot; 6. Second connection block; 7. Third connection block.

### DETAILED EMBODIMENTS

In order to make the technical problem, technical solution and beneficial effect to be solved by the present invention more clearly understood, the present invention is further described in detail below in conjunction with the accompanying drawings and embodiments. It should be understood that the specific embodiments described herein are only used to explain the present invention and are not used to limit the present invention.

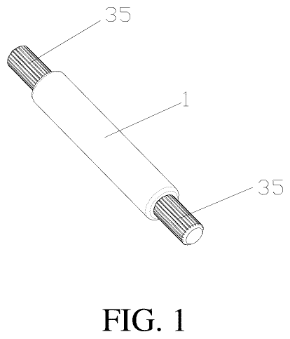

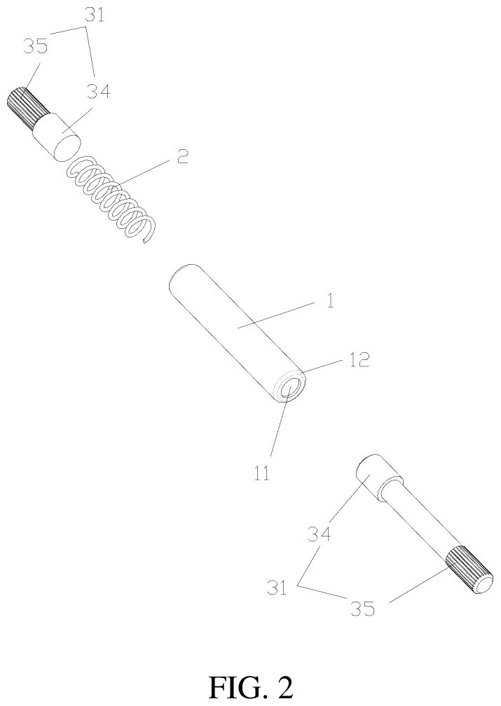

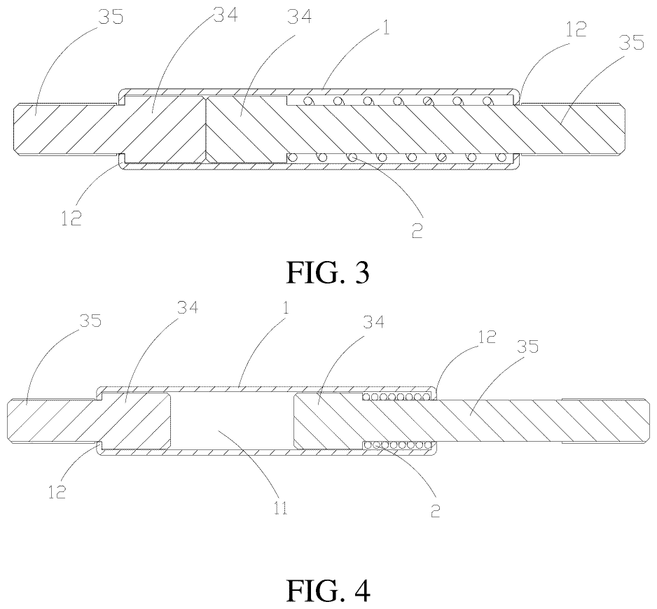

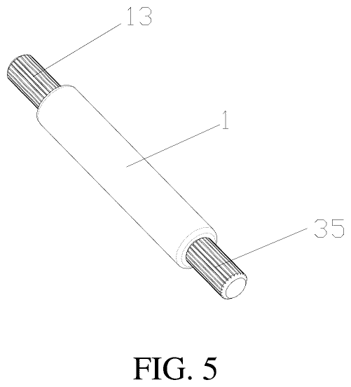

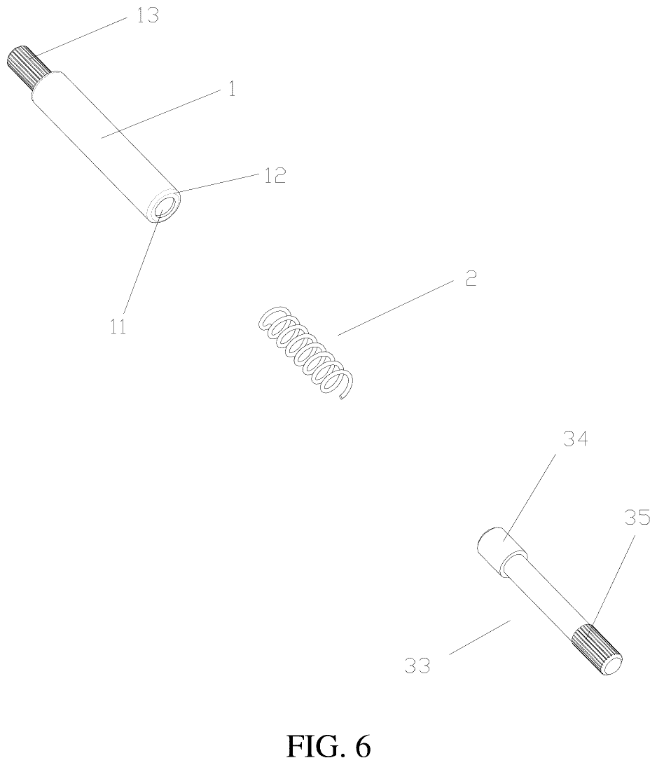

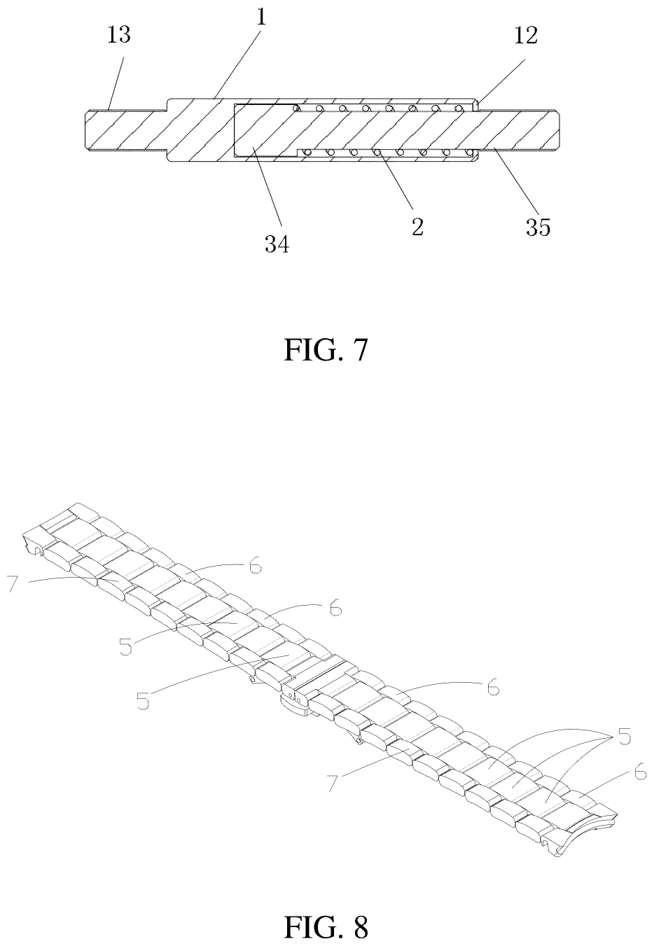

An elastic connection mechanism is provided, as shown in FIGS. 1 to 7, including two embodiments. Specifically, in Embodiment 1, an elastic connection mechanism 100 includes a sleeve 1, a spring 2, a first rod body 31 and a second rod body 32. The sleeve is provided with a cavity 11 extending through the sleeve, and steps 12 are provided at outlets at both ends of the cavity. The first rod body and the second rod body each include a base 34 matching the diameter of the cavity, and a needle rod 35 having a diameter smaller than the diameter of the base and integrally connected to the base.

The base of the first rod body is positioned in the cavity and abuts against the step on one side of the sleeve. The needle rod of the first rod body extends out of the cavity, and is configured to connect to a first preset structural member.

The spring is sleeved on the needle rod of the second rod body. The base of the second rod body is positioned in the cavity. One end of the base of the second rod body is arranged opposite to the base of the first rod body. The spring is located between another end of the base of the second rod body and the step on another side of the sleeve. The needle rod of the second rod body extends out of the cavity, and is configured to connect a second preset structural member.

The first preset structural member and the second preset structural member are arranged at two ends to be connected by the elastic connection mechanism. When the spring is in an extended state, the base of the second rod body abuts against the base of the first rod body. When the second rod body moves in a direction away from the first rod body, the base of the second rod body compresses the spring to a compressed state.

In Embodiment 2, the elastic connection mechanism 100 includes a sleeve 1, a spring 2, and a third rod body 33. A fixing rod 13 is provided at one end of the sleeve. A cavity 11 is provided in another end of the sleeve, and a step 12 is provided at an outlet of the cavity. The third rod body includes a base 34 matching the diameter of the cavity, and a needle rod 35 having a diameter smaller than the diameter of the base and connected to the base in one piece.

The fixing rod of the sleeve is configured to connect to a first preset structural member.

The spring is sleeved on the needle rod of the third rod body. The base of the third rod body is positioned in the cavity. One end of the base of the third rod body is arranged opposite to a bottom of the cavity. The spring is located between another end of the base of the third rod body and the step of the sleeve. The needle rod of the third rod body extends out of the cavity, and is configured to connect to a second preset structural member.

The first preset structural member and the second preset structural member are arranged at two ends to be connected by the elastic connection mechanism. When the spring is in an extended state, the base of the third rod body abuts against the bottom of the cavity. When the third rod body moves in a direction away from the bottom of the cavity, the base of the third rod body compresses the spring to a compressed state. The sleeve and its fixing rod adopt an integrated design to replace the sleeve and the first rod body in Embodiment 1, such that it has a simpler and more solid structure.

Further, for the above embodiments, the steps can be formed from a process using a crimping, riveting, or press-fit snap-fit fastener, or a welded snap-fit fastener made from a discrete component, but is not limited thereto. In one embodiment, the steps are in a shape of a circular ring, and the diameter of a center hole of the circular ring matches the diameter of the needle rod to facilitate extension of the needle rod.

Furthermore, the ends of the needle rod of the first rod body, the needle rod of the second rod body, and the needle rod of the third rod body are any one of a thread-rolling toothed needle, pineapple-shaped needle, a screw, and a connection groove for connecting with the first preset structural member and the second preset structural member.

Furthermore, the cavity of the sleeve is cylindrical in shape. The bases of the first rod body, the second rod body, and the third rod body are all matched with the shape of the cavity. However, the shape of the sleeve cavity is not limited thereto.

A device based on the elastic connection mechanism is provided, including the elastic connection mechanism 100, a first preset structural member, and a second preset structural member. Among them, the first preset structural member and the second preset structural member are respectively connected to the needle rod of the first rod body and the needle rod of the second rod body; or, the first preset structural member and the second preset structural member are respectively connected to the fixed rod of the sleeve and the needle rod of the third rod body.

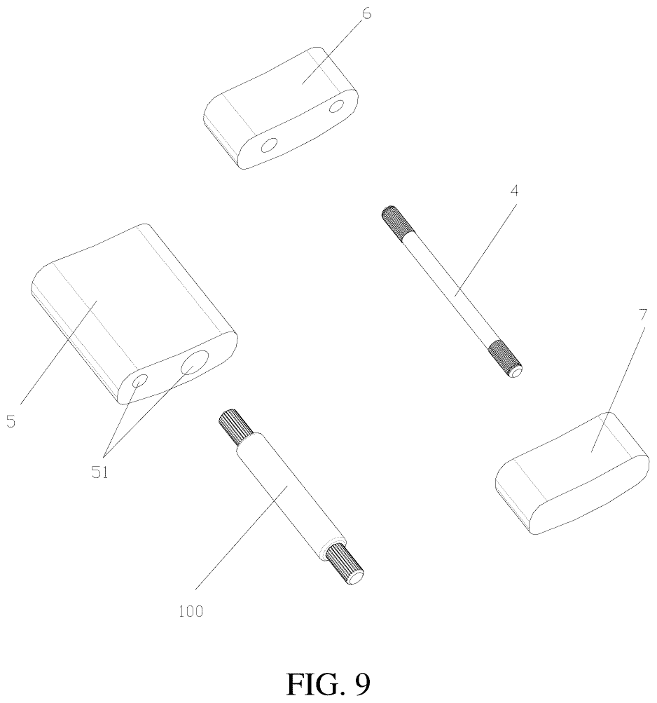

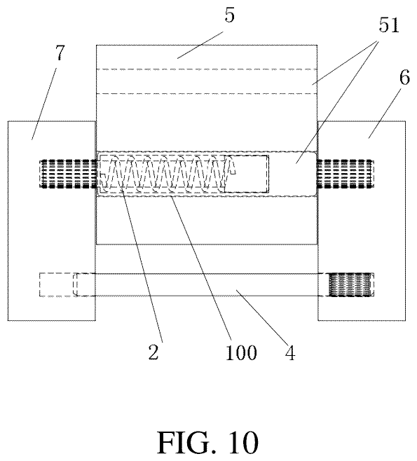

In one embodiment, as shown in FIGS. 8 to 10, the device based on the elastic connection mechanism is a watchband unit. The watchband unit includes a first connection block, and a second connection block and a third connection block arranged on both sides of the first connection block. The first preset structural member and the second preset structural member are respectively equivalent to the second connection block and the third connection block. The elastic connection mechanism is installed on the first connection block. The second connection block and the third connection block are connected by the first rod body and the second rod body, or the third rod body and the fixed rod.

Specifically, a plurality of watchband units are connected to form a watchband. Each watchband unit includes a positioning shaft 4, an elastic connection mechanism 100, a first connection block 5, and a second connection block 6 and a third connection block 7 respectively assembled on both sides of the first connection block.

Among them, two through slots 51 are arranged in parallel in the first connection block, namely: a first through slot and a second through slot. After the positioning shaft passes through the first through slot, one end of the positioning shaft is fixedly connected or movably connected to the second connection block in the adjacent watchband unit, and the other end is movably connected to the third connection block in the adjacent watchband unit. The movable connection means that one end of the positioning shaft can be detached from the third connection block. For example, an axial hole is arranged on the third connection block, and a movable connection is formed after one end of the positioning shaft is inserted into the axial hole.

Specifically, when there is only one first connection block, one end of the positioning shaft is fixedly connected to the second connection block, and the other end is movably connected to the third connection block. When there are multiple first connection blocks, for easy disassembly and assembly, two ends of the positioning shaft are respectively movably connected to the second connection block and the third connection block.

After the elastic connection mechanism passes through the second through slot, two ends of the elastic connection mechanism are fixedly connected to the second connection block and the third connection block in the current watchband unit respectively.

When in use, for the elastic connection mechanism in Embodiment 1, when the spring is extended, the base of the second rod body is in contact with the base of the first rod body. When the third connection block is pulled up, the base of the second rod body moves toward the third connection block and pushes the spring to compress. At the same time, the third connection block moves away from the first connection block, so that the movable connection end of the positioning shaft is separated from the third connection block. At this time, the third connection block can be rotated with the axial direction of the elastic connection mechanism 100 as the center of a circle to achieve disassembly. Similarly, for the elastic connection mechanism in Embodiment 2, when the third connection block is pulled up, the base of the third rod body moves toward the third connection block and pushes the spring to compress, so that the positioning shaft and the third connection block can be separated.

In the watchband unit based on the elastic connection mechanism, the elastic connection mechanism not only allows the watchband unit to be disassembled and assembled by hand, but also has a simpler structure, which is convenient for production and assembly.

The above is an explanation of the elastic connection mechanism and application of the present invention, which is used to help understand the present invention. However, the embodiments of the present invention are not limited to the above-mentioned embodiments. Any change, modification, substitution, combination, and simplification made without departing from the principle of the present invention should be equivalent replacement methods and are included in the scope of protection of the present invention.

What is claimed is:

1. An elastic connection mechanism, characterized in that: it comprises a sleeve, a spring, a first rod body and a second rod body; the sleeve is provided with a cavity extending through the sleeve, and steps are provided at outlets at both ends of the cavity; the first rod body and the second rod body each comprise a base matching a diameter of the cavity, and a needle rod having a diameter smaller than a diameter of the base and integrally connected to the base;
the base of the first rod body is positioned in the cavity and abuts against the step on one side of the sleeve, the needle rod of the first rod body extends out of the cavity, and is configured to connect to a first preset structural member;
the spring is sleeved on the needle rod of the second rod body; the base of the second rod body is positioned in the cavity, one end of the base of the second rod body is arranged opposite to the base of the first rod body, the spring is located between another end of the base of the second rod body and the step on another side of the sleeve; the needle rod of the second rod body extends out of the cavity, and is configured to connect a second preset structural member;
when the spring is in an extended state, the base of the second rod body abuts against the base of the first rod body; when the second rod body moves in a direction away from the first rod body, the base of the second rod body compresses the spring to a compressed state.

2. An elastic connection mechanism, characterized in that: it comprises a sleeve, a spring and a third rod body; a fixing rod is provided at one end of the sleeve, a cavity is provided in another end of the sleeve, and a step is provided at an outlet of the cavity; the third rod body comprises a base matching a diameter of the cavity, and a needle rod having a diameter smaller than a diameter of the base and connected to the base in one piece;
the fixing rod of the sleeve is configured to connect to a first preset structural member;
the spring is sleeved on the needle rod of the third rod body; the base of the third rod body is positioned in the cavity, one end of the base of the third rod body is arranged opposite to a bottom of the cavity, and the spring is located between another end of the base of the third rod body and the step of the sleeve; the needle rod of the third rod body extends out of the cavity, and is configured to connect to a second preset structural member;
when the spring is in an extended state, the base of the third rod body abuts against the bottom of the cavity; when the third rod body moves in a direction away from the bottom of the cavity, the base of the third rod body compresses the spring to a compressed state.

3. The elastic connection mechanism as claimed in claim 1, characterized in that: the steps are formed from a process using a crimping, riveting, or press-fit snap-fit fastener, or a welded snap-fit fastener made from a discrete component.

4. The elastic connection mechanism as claimed in claim 2, characterized in that: the steps are formed from a process using a crimping, riveting, or press-fit snap-fit fastener, or a welded snap-fit fastener made from a discrete component.

5. The elastic connection mechanism as claimed in claim 1, characterized in that: the steps are in a shape of a circular ring, and a diameter of a center hole of the circular ring matches the diameter of the needle rod.

6. The elastic connection mechanism as claimed in claim 2, characterized in that: the steps are in a shape of a circular ring, and a diameter of a center hole of the circular ring matches the diameter of the needle rod.

7. The elastic connection mechanism as claimed in claim 1, characterized in that: ends of the needle rod of the first rod body, the needle rod of the second rod body and the needle rod of the third rod body are any one of a thread-rolling toothed needle, pineapple-shaped needle, a screw, and a connection groove.

8. The elastic connection mechanism as claimed in claim 2, characterized in that: ends of the needle rod of the first rod body, the needle rod of the second rod body and the needle rod of the third rod body are any one of a thread-rolling toothed needle, pineapple-shaped needle, a screw, and a connection groove.

9. The elastic connection mechanism as claimed in claim 1, characterized in that: the cavity of the sleeve is cylindrical in shape; and the bases of the first rod body, the second rod body and the third rod body are all matched with a shape of the cavity.

10. The elastic connection mechanism as claimed in claim 2, characterized in that: the cavity of the sleeve is cylindrical in shape; and the bases of the first rod body, the second rod body and the third rod body are all matched with a shape of the cavity.

11. A device based on an elastic connection mechanism, characterized in that: the device comprises the elastic connection mechanism as claimed in claim 1, a first preset structural member, and a second preset structural member; wherein the first preset structural member and the second preset structural member are respectively connected to the needle rod of the first rod body and the needle rod of the second rod body; or, the first preset structural member and the second preset structural member are respectively connected to the fixed rod of the sleeve and the needle rod of the third rod body.

12. A device based on an elastic connection mechanism, characterized in that: the device comprises the elastic connection mechanism as claimed in claim 2, a first preset structural member, and a second preset structural member; wherein the first preset structural member and the second preset structural member are respectively connected to the needle rod of the first rod body and the needle rod of the second rod body; or, the first preset structural member and the second preset structural member are respectively connected to the fixed rod of the sleeve and the needle rod of the third rod body.

13. A device based on an elastic connection mechanism, characterized in that: the device comprises the elastic connection mechanism as claimed in claim 3, a first preset structural member, and a second preset structural member; wherein the first preset structural member and the second preset structural member are respectively connected to the needle rod of the first rod body and the needle rod of the second rod body; or, the first preset structural member and the second preset structural member are respectively connected to the fixed rod of the sleeve and the needle rod of the third rod body.

14. A device based on an elastic connection mechanism, characterized in that: the device comprises the elastic connection mechanism as claimed in claim 4, a first preset structural member, and a second preset structural member; wherein the first preset structural member and the second preset structural member are respectively connected to the needle rod of the first rod body and the needle rod of the second rod body; or, the first preset structural member and the second preset structural member are respectively connected to the fixed rod of the sleeve and the needle rod of the third rod body.

15. A device based on an elastic connection mechanism, characterized in that: the device comprises the elastic connection mechanism as claimed in claim 5, a first preset structural member, and a second preset structural member; wherein the first preset structural member and the second preset structural member are respectively connected to the needle rod of the first rod body and the needle rod of the second rod body; or, the first preset structural member and the second preset structural member are respectively connected to the fixed rod of the sleeve and the needle rod of the third rod body.

16. A device based on an elastic connection mechanism, characterized in that: the device comprises the elastic connection mechanism as claimed in claim 6, a first preset structural member, and a second preset structural member; wherein the first preset structural member and the second preset structural member are respectively connected to the needle rod of the first rod body and the needle rod of the second rod body; or, the first preset structural member and the second preset structural member are respectively connected to the fixed rod of the sleeve and the needle rod of the third rod body.
